(19) United States
(12) Patent Application Publication
(10) Pub. No.: US 2004/0205394 A1
(43) Pub. Date: Oct. 14, 2004

(54) Method and apparatus to implement an errands engine

(76) Inventor: Mark Earl Plutowski, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/739,553

(22) Filed: Dec. 17, 2003

Related U.S. Application Data
(60) Provisional application No. 60/456,035, filed on Mar. 17, 2003.

(51) Int. Cl. H02H 3/05

(52) U.S. Cl. 714/21

(57) ABSTRACT

A method and apparatus for providing an errands engine is described. The errands engine comprises an errand receiving logic to receive a set of tasks comprising an errand, a starting state identification logic to generate a characteristic function that describes a set of valid starting states, and a solution logic to generate a tour to complete the errand.

### RELATED APPLICATIONS

The present invention claims priority to U.S. Provisional Application Serial No. 60/456,035, filed Mar. 17, 2003, and incorporates that application in its entirety.

### FIELD OF THE INVENTION

The present invention relates to routing, and more particularly to optimizing routing to multiple locations.

### BACKGROUND

Currently available errands engines generally provide point-to-point routing through a deterministic set of points. If a user wishes to run errands, the prior art techniques require him or her to enter a starting position, and each subsequent location in order. The prior art plans assume that the ordering of the errands is predetermined. Furthermore, prior art services do not provide contingency planning for handling failures in the route.

The application scenario, and the larger class of problems in which it resides, have been considered at great length by the planning and scheduling community. However, the prior art solutions utilize techniques that either require deterministic operators (i.e., cannot handle probabilistic operators), or cannot handle real-valued utility functions, or do not deliver an optimal solution.

### SUMMARY

A method and apparatus for providing an errands engine is described. The errands engine comprises an errand receiving logic to receive a set of tasks comprising an errand, a starting state identification logic to generate a characteristic function that describes a set of valid starting states, and a solution logic to generate a tour to complete the errand.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of one embodiment of a network on which the errands engine may be used.

FIG. 2 is a block diagram of one embodiment of an errands engine in accordance with the present invention.

FIG. 3A is a block diagram of one embodiment of a user system for the errands engine in accordance with the present invention.

FIG. 3B is an exemplary user interface for defining a set of errands.

FIG. 4 is a flow diagram of one embodiment of generating a route using the errands engine.

FIGS. 5A and 5B are a policy diagram and a pruned policy diagram in accordance with the present invention.

FIG. 6 is a block diagram of a computer system on which the present invention may be implemented.

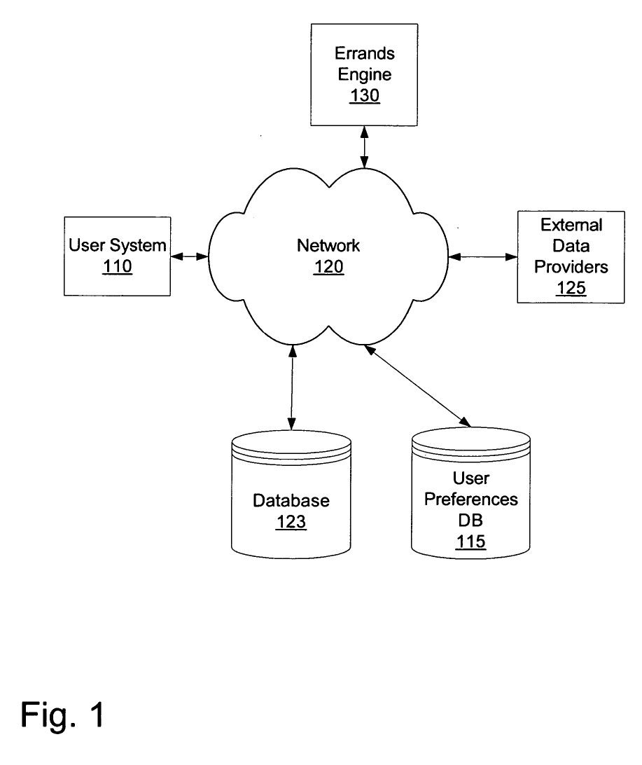

### DETAILED DESCRIPTION

A method and apparatus for an errands engine is described. The errands engine is designed for the optimal sequencing of visitation over a set of locations for fulfilling a set of errands under an objective criterion function, taking into account costs, probability of availability of desired resource, and rewards for obtaining resource. In one embodiment, the sequencing is performed using Symbolic-Heuristic approach (decision-theoretic symbolic model checking combined with symbolic heuristic search).

The general problem space to which this errands engine solution may be applied involves task of generating an optimal route for locating a set of resources across a set of locations. The errands engine described herein, in one embodiment, includes in its calculations the inherent uncertainty that a given resource will be available at a particular location, while optimizing performance over cost of visiting a location, cost of acquiring the resource from a location, and reward for acquiring the resource from a location. The errands engine is suitable for location-aware tasks, such as fulfilling a shopping list across a set of stores, nonphysical (cyber-space) applications such as optimally sequencing the visitation of a set of resources located on a network, automating sequencing useful for creating workflow tasks, programming game characters and robotic toys, and other multi-step tasks.

The invention handles “resource stores” or locations where the desired resource is available (simply referred to herein as “store” or “location”) which may or may not possess the desired resource. The triggering mechanism (simply referred to herein as “user”) may be an individual, a device, an application program, or any other entity that may trigger the errands engine. A policy is created that directs the user to locate the next location with the best expected utility, where utility is a composition of cost and reward. Costs account for travel time or expense. Rewards account for subjective value and monetary cost of attempting to obtain the resource.

In one embodiment tasks are posed as Markov decision processes (MDP). An MDP is a tuple (S, A, P, R). S is a set of states. A is a set of actions. P is a set of transition models, one per action, specifying the transition probabilities Pₐ:S×S→[0, 1]. R is a reward Rₐ: S→R, where R is the set of real numbers. The objective is to find a policy π:S→A that maximizes expected discounted reward over a horizon Hε0,1, . . . , ∞, where Dε[0,1] is the discount factor.

Consider a set of M “resources” R_{M}={r₁, . . . , r_{M}} (elsewhere referred to as “items”), and L “locations” (respectively “stores”), X_{L}={x₁, x₂, . . . , x_{L}}. A reasoning agent seeks to obtain M resources by sequentially visiting some subset of the stated locations. S=S_{L}×S_{D}×S_{M}×S_{φ}. The “null” state S_{φ} is an absorbing state used to explicitly trap illegal or otherwise “bad” moves. S_{D}=2^{{X}^{_{L}}^{}} tracks where the agent has been previously, where 2^{{Z}} is the power set obtained by taking all subsets of Z (i.e., all combinations of elements of Z and including the empty subset) for some set Z. S_{M}=2^{{R}^{_{M}}^{}} tracks which among the M desired resources have been acquired by the agent. In the problem formulation S_{L} states the current location.

In one embodiment, S_{L}=X_{L}. Therefore, in this embodiment #S_{L}=L, #S_{D}=2^{D}, #S_{M}=2^{M}, and #S_{φ}=2. In this embodiment, the state variable encoding for representing location uses a binary encoding using at least log₂ (L) bits (the binary logarithm must be rounded up to the next nearest integer value). For given M and L, the size of this state space is L−2^{L+M+1}.

In another embodiment, the size of the state space is reduced further by taking S_{φ} to be mutually exclusive of the other substate vectors, in which case S={S_{L}×S_{D}×S_{M}}∪S_{φ}. For given M and L, the size of this state space is L2^{L+M}+1.

In another embodiment S_{L}=2^{{X}^{_{L}}^{}}, and when selecting SεS_{L} the errands engine enforces that exactly one xᵢ=1, 1≦i≦L, setting the remainder to zero. This simplifies the tasks of generating the MDP encoding and of extracting the policy, but increases the size of the state space such that in this embodiment #S_{L}=2^{L}. For given M and L, the size of this state space is 2^{2L+M+1}. In one embodiment, this implementation utilizes a MDP solver having space and time complexity that is less affected by the size of the search space, including techniques using a reachability step that prunes away unreachable states from consideration such as sLAO*.

Let actions A={g_{x,y}, x≠y, xεX_{L}, yεX_{L}}∪g₀, where g_{x,y} is “go from x to y,” and g₀ is “stay.” Therefore, #A=L(L−1)+1. This representation does not explicitly provide actions for obtaining resources, but rather implicitly assumes that the agent will (probably) pick up available resources upon visiting a location, thereby greatly reducing the number of actions required to represent the task. In one embodiment the reasoning agent is rewarded for picking up an item it doesn't already have.

Some of the locations are also designated as rendezvous locations. The agent is additionally rewarded for completing the tour at a rendezvous once it has acquired the desired resources. In one embodiment the agent is rewarded for obtaining one or more of the desired resources. In another embodiment the agent is given an additional reward for obtaining all of the desired resources. In one embodiment the errands engine uses an encoding that tracks the states that have been visited via the state variable SD, allowing it to penalize the agent for revisiting location unnecessarily (i.e., if the location does not possess anything that the agent still needs). This penalty is avoided if the store has at least one item on the agent's active shopping list, or if the location is a rendezvous point and the active shopping list is empty.

To be somewhat more precise with respect to specifying the rewards, in one embodiment, reward is given by the immediate value of a state minus the action cost. R^{a}(s)=Rᵣ(s)−R_{c}(a), sεS and aεA, where Rᵣ:S→R and R_{c}:A→R⁺, where R⁺={xεR, x≧0}. For locations x and y in one embodiment R_{c}(g_{x,y}) is the time required in traveling from x to y. In another embodiment R_{c}(g_{x,y}) is the distance covered in traveling from x to y. The travel time (respectively, distance) between any two given locations is asymmetric, i.e. the time (resp., distance) from x to y may be more or less than the reverse direction, i.e. in general R_{c}(g_{x,y})≠R_{c}(g_{y,x}).

To be somewhat more precise with respect to specifying the allowable transitions, one embodiment prohibits revisits altogether by modifying the state transitions to disallow visits to any location that is already designated in SD. Another embodiment allows useful revisits but disallows unnecessary revisits by modifying the state transitions to allow visits to any location that is designated in SD but where either one of two cases holds: (a) the location carries in its inventory at least one resource with probability of availability that is greater than zero, such that the resource is not yet designated in S_{M} (i.e., the location possesses something the agent needs), or (b) all items have been acquired (i.e., S_{M} is all “1's”), and the location is a rendezvous. Another embodiment does not utilize the tracking state variables S_{D}, and allows unrestricted revisits to any location. This embodiment utilizes a nonstationary policy that is recomputed on the fly when the policy recommends revisiting a location. This embodiment reduces the size of the state space greatly, thereby reducing the time required to obtain a policy, at the expense of generally requiring replanning during run-time to avoid unnecessary or undesirable revisits.

In one embodiment the errands engine uses an additional data structure to represent dependencies between goals. Let G be an acyclic directed graph over items R_{M}={r₁, . . . , r_{M}}. Given two nodes rᵢ and rⱼ in G, an edge from rᵢ to rⱼ represents a dependency such that rᵢ must be obtained before rⱼ can be obtained (i.e., goal rᵢ is a precondition of goal rⱼ). The graph can be disconnected. (In a connected graph there is a path from any point to any other point in the graph. A graph that is not connected is said to be disconnected.) A node representing an item (respectively a “desired resource”) which is disconnected has no dependencies on any other goal. A node rⱼ in G may have a plurality of dependencies, represented by having edges from a plurality of other nodes. In one embodiment, these dependencies are encoded in the MDP by preconditions in the transition diagram. This encoding stipulates that when a goal has any preconditions, those preconditions must hold before the goal can be attained.

A similar data structure and encoding may be used, in one embodiment, to specify preconditions for actions, i.e., other actions that must have already been “fired” before an action is enabled. Another embodiment utilizes a more general encoding that specifies for each action a set of states, one or more of which must hold in order for the action to be enabled. Another embodiment utilizes an encoding that specifies for each goal a set of states, one or more of which must hold before the goal can be attained. This set of states can be represented as a decision diagram, decision tree, look-up table, or other standard representation of state utilized in encoding MDPs.

The Errands Engine is especially well-suited for location-based activities that transpire in physical (geographically situated) space and time or some analog or simulation thereof, such as a virtual world (e.g., computer game), or behavioral control of a autonomous mobile robot. At first glance the Errands Engine seems to be restricted to location-based activities—however, the Errands Engine can be easily adapted to performing decisioning processes situated in cyberspace. The term “cyberspace” refers to networked environments, such as the dynamic composition of composite services from web services situated on the world wide web. In this application, the L locations refer to L web services. This adaptation is achieved by replacing actions A with actions A^{www}={g_{y}, yεX_{L}}∪g₀, where g_{y} is “go to y,” and g₀ is “stay.” Therefore, #A^{www}=L+1. Intuitively, each location y represents a single web service. Note that the cost of accessing a web service does not depend upon a “current location,” and in particular, does not depend upon the immediately previous web service accessed by the system.

In one embodiment the errands engine uses conventional MDP (Markov decision process) solvers (also referred to in the jargon of the field as “flat”, or “classical” techniques) such as value iteration, policy iteration, modified policy iteration, or linear programming. In another embodiment, the errands engine uses algorithms based upon decision-theoretic regression using symbolic model-checking to solve MDPs, combined with a symbolic heuristic search strategy (sLAO*). Symbolic Model Checking is an efficient way to apply dynamic programming to value iteration by automatically exploiting structure in the problem. In the technical jargon this is also referred to as a “structure” approach, or as using a “factored” representation. Symbolic LAO* is a heuristic search technique that also automatically exploits structure in the problem. Combining these two approaches combines dynamic programming into heuristic search. This technique is referred to herein as a “Symbolic-Heuristic” search.

The Symbolic-Heuristic approach provides the algorithms which provide an errands engine with:

(a) Expressiveness—able to solve stochastic planning tasks formulated as an MDP,

(b) Optimality—able to generate the optimal value function for a given MDP task,

(c) Space Complexity—able to exploit problem structure via an efficient data structure

(d) Time Complexity—able to avoid wasting computation on unreachable states.

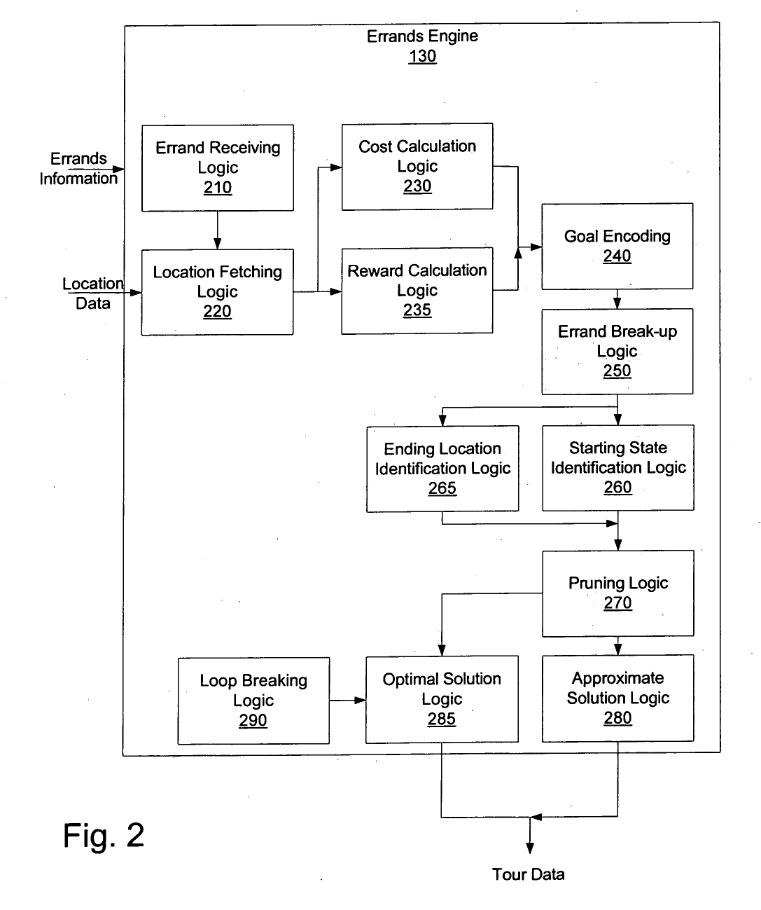

FIG. 2 illustrates a block diagram of one embodiment of the errands engine 130. Errand receiving logic 210 receives the errand definition from a user. In one embodiment, the user simply lists a set of tasks to be accomplished. In another embodiment, the user defines any dependencies in the task. For example, the tasks may be going to an ATM, purchasing a present, and getting a drink. The purchase of the present and drink may be dependent on first going to an ATM to obtain money. In one embodiment, the user defines these dependencies. In another embodiment, as will be described below, the errands engine 130 identifies such dependencies.

Location fetching logic 210 obtains a set of locations for the stores at which the requested resources are available. In the above example, the location fetching logic 210 would obtain locations of ATMS, locations of stores that sell beverages, and locations that sell presents. In one embodiment, the preferences for present type is defined by the user, i.e. the user indicates he/she wishes to purchase a watch, and the location fetching logic 210 fetches stores which sell watches. In one embodiment, the location fetching logic 210 fetches a set of locations, for example, it fetches ten locations.

Cost calculation logic 230 calculates the costs of obtaining the resource at each location. The cost includes the physical cost of an item (i.e. a charge at the ATM, the cost of a drink, etc.) and the transaction cost (i.e. travel time).

Reward calculation engine 240 calculates the subjective value of accomplishing each task. This, in one embodiment, enables the errands engine 130 to complete only a subset of tasks having the highest rewards, in a constrained situation. The constraint may be time, distance traveled, or any other constraint set by the user. In one embodiment, the user may identify “necessary” tasks. For example, in the above example, the user may identify the tasks of going to an ATM and purchasing a present as “necessary” while the task of getting a drink is optional. In one embodiment, the system may default to assuming that all tasks are optional. In another embodiment, the system may default to assuming that all tasks are necessary. In one embodiment, the user may set his or her preferences, as to the default assumption.

Goal encoding 240 encodes the goals set by the user (i.e. the tasks) for the calculations. In one embodiment, the task is formulated to exploit the benefits of the Symbolic-Heuristic approach. The encoding used minimizes the number of state variables and exploits beneficial characteristics of both the Symbolic Model Checking approach (used to obtain the initial heuristic), and the Symbolic-Heuristic approach (used to compute the policy). In one embodiment, the encoding provides a result that is very flexible and applicable to a wide class of tasks. However, in one embodiment, certain decisions are offloaded to exogenous processes to reduce the search space considered by the errands engine.

Errand break-up logic 250, in one embodiment, breaks up two step errands. The errand break-up logic 250 supports resources that are obtained in two distinct steps, each step separated by some given length of time.

For example, when dropping off a roll of photographic film at a Photo Shop that provides 1-hour film developing services, the user must first visit the Photo Shop to drop off the film, and then must wait at least one hour before returning the pick up the film. In one embodiment, the errands engine allows another state variable to track the passage of the desired unit of time for the particular activity (in this example, one hour from the time it is dropped off), and then “rewards” the errands engine when the film is picked up. The reward is specified to provide a reward in the case of this set of events: (1) the user visits the Photo Shop, (2) one hour passes, and (3) the user visits the Photo Shop again. The Errands engine can decide that it is better to wait rather than leave and attempt another task given the allotted time. For example, say the user is dropping off an automobile at a service station for an oil change that is expected to require 15 minutes. The Errands engine 130 computes the cost of completing another errand on its list and decides that the net cost (reward minus travel cost) of doing so does not exceed the cost of just waiting the 15 minutes.

In one embodiment, for each such two-step task, the underlying MDP is supplemented with one additional multivariate state variable T_{τ}={t_{τ}, . . . , t_{τ}}, where T_{τ} is a Boolean representation of the number of time steps that have transpired since the first-step of the two-step task was initiated, such that T_{τ}ε{(0,0, . . . ,0, 0), (0,0, . . . ,0,1), (0,0 . . . , 1,0), (0,0, . . . , 1,1), . . . , (1,1, . . . , 1,0), (1,1, . . . , 1,1)}.

In this embodiment, the second step of the two-step task is enabled when T_{τ}={1,1, . . . , 1}, (i.e., is all ones). In this embodiment, each “tick” (i.e., time step) of this “stopwatch” variable corresponds to a unit of time, such as 15 minutes. In this embodiment, every action may update this stopwatch variable and increment it according to the amount of time that the particular action expends. Once T_{τ} is set to all ones, it remains at that value until the second step of the two step task is completed. In this embodiment the stopwatch variable can represent 2^{τ}−1 time steps. In another embodiment, a unary encoding is used for the stopwatch variable, such that T_{τ}ε{(0,0, . . . ,0,0), (0,0, . . . ,0,1), (0,0, . . . ,1,1), (0,1, . . . ,1,1), (1,1, . . . ,1,1)}. In this embodiment, the stopwatch variable can represent at most τ time steps. In another embodiment, a “one-of-K” encoding is used, such that for some integer K, and τ=K, T_{τ}ε{(0,0, . . . , 0,0), (0,0, . . . ,0,1), (0,0, . . . ,1,0), (0,1, . . . ,0,0), (1,0, . . . ,0,0)}. In this embodiment, the stopwatch variable can represent at most τ time steps. In each of these additional embodiments, the second step of the two-step task is enabled when the highest order bit (i.e., the leftmost bit as written here) is set to 1. Once the stopwatch variable attains its highest value, it remains at that value until the second-step of the two-step task is completed.

In one embodiment, an additional “wait” action is added to the action set, such that the “wait” action causes the agent to remain at the same location and has no other effect than to increment the stopwatch variable by one tick (i.e., to expend one unit of time).

The starting state identification logic 260 defines the “initial situation” used by the Symbolic-Heuristic approach. The starting state identification logic 260, in one embodiment, exploits regularities in the task description encoding to specify all of the valid starting states, and then create a composite “initial situation” specified by the characteristic function that describes the set of valid starting states. This allows an MDP solver that can exploit reachability structure (such as sLAO*) to compute a policy valid for all valid starting states, not just a single start state. In another embodiment, the starting state identification logic 260 specifies a single valid starting state. This allows an MDP solver that can exploit reachability structure (such as sLAO*) to compute the value and policy only for those states reachable from the given starting state.

The rendezvous logic 265 identifies the locations at which the Tour designed by the errands engine 130 can end. In one embodiment, the Tour may end in any location. In one embodiment, the errands engine 130 allows a subset of the Stores to be designated as “Rendezvous Locations”. A Rendezvous Location is a location at which the errands engine may end its Tour. A Rendezvous Location need not contain any Resources.

For example, two people may go shopping together, and then decide to split up for some time to pursue their own individual errands. They decide to meet when they have completed their individual tasks. They designate a Rendezvous Location such as a park (which does not contain any resources on either of their respective Shopping Lists), or a coffee shop (which may contain a resource that appears on one of their Shopping Lists). In one embodiment, the errands engine also allows more than one Rendezvous Location to be designated. This allows the first person to complete their respective tasks to wait at the Rendezvous Location of their choice, and then telephone the other person to let them know where they are waiting. Thus, the Tour should end at a rendezvous location, if one is defined. Whether the Tour actually ends at a rendezvous depends upon the reward for doing so versus the cost of traveling to the rendezvous. The reward can be set such that the Tour must end at a rendezvous by setting the reward to be greater than the maximum cost for traveling to the rendezvous.

Pruning logic 270 removes any unreachable states. In MPD solvers certain states will not be encountered because the state transition diagram (that stipulates how one state may be reached from another by executing an action) may prohibit those states from ever being reached in normal use. In other words, such states are “unreachable” from a particular set of starting states. These “unreachable states” based on the starting states identified by starting state identification logic 260 and ending states identified by rendezvous logic 265, are masked. This means that the errands engine 130 does not calculate these unreachable states. This significantly reduces the complexity of the value diagram and policy diagram. It is quite common to have no-masked value diagrams with hundreds of thousands of nodes, which can be reduced by masking to tens of thousands of nodes, a reduction on the order of 90%. The reduction, of course, depends on the problem and the reachability structure of the problem.

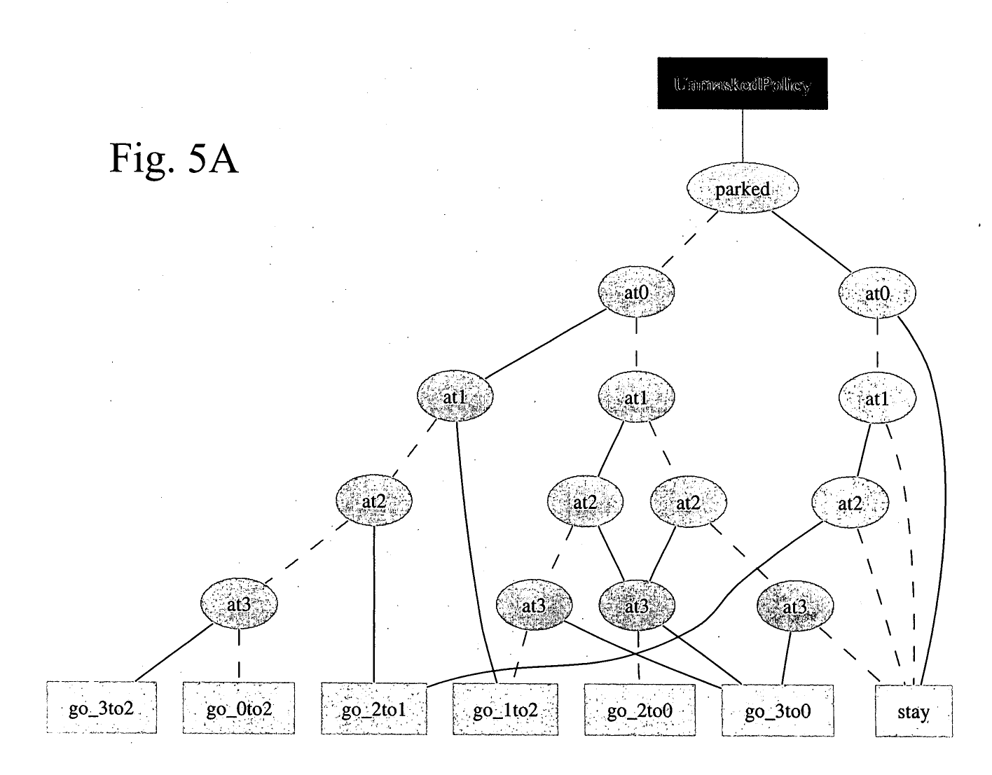

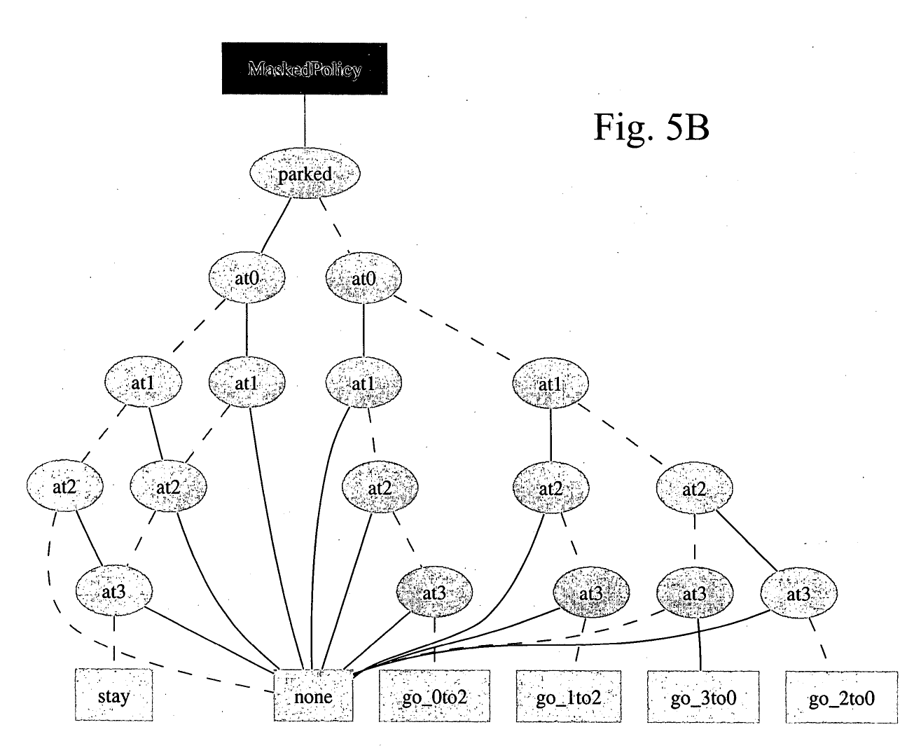

FIGS. 5A and 5B illustrate the difference between a pruned (masked) policy diagram and a non-masked policy diagram. As can be seen, the pruned policy diagram is less complex since it does not contain policy for unreachable states, whereas the unmasked policy diagram does.

One beneficial by-product of an MDP solver that exploits reachability (such as Symbolic LAO*) is that the resulting value function excludes mention of unnecessary states, and the resulting policy generates a “null” action for all unreachable states. FIGS. 5A and 5B illustrate the difference between policy generated by the blind exhaustive approach of Spudd, versus the “masked” policy (in this case, generated by LAO*).

FIG. 5A shows an unmasked policy for a simplified version of the errands task, using four location SVs (at0, at1, at2, at3) and a single resource SV (parked). (Tracking SVs, which allow the policy to avoid revisiting locations, have been omitted to simplify the figure.) Internal (i.e., non-terminal) nodes represent SVs. If an SV is true, follow the solid line, otherwise follow the dashed line. Leaf (i.e., terminal) nodes represent actions. For example, the action for parked AND at0 (given all other SVs are false) is stay. The action for at3 (given all other SVs are false) is go_{—}3to0. Any node with more than one location variable set to true is unreachable—these nodes will never be accessed. For example, the action for at0 AND at1 (given all other SVs are false) is go_{—}1to2. This illustrates that the policy generated by the (unmasked) value iteration algorithm contains policy for unreachable states.

FIG. 5B shows the masked policy for the same task as in the FIG. 5A. The masked policy masks out unreachable states. As can be seen, in one embodiment, all unreachable states trap to a single terminal node labeled “none.”

For example, in a situation with 11 locations, 6 resources, and 29 state variables in all, in one embodiment the total number of states as encoded is over 536,870,912. However, the number of reachable states is only 2,883,584. This is because of sparseness in the Location State Variables, because the errands engine must be in exactly one location at any one time, and under this encoding exactly one Location State Variable is set to one, and there are 11 locations. Therefore only 0.54% of the states are reachable. Conventional value iteration using exhaustive (and blind) search spends cycles evaluating the 99.46% of the states that can never be encountered in actual use.

Returning to FIG. 2, in one embodiment, the system provides approximate solutions as well as optimized solutions. In one embodiment, the errands engine 130 includes an optimized solution generator 285 and an approximate solution generator 280.

The approximate solution generator 280 integrates the data structure of the “pair terminal” ADD into the sLAO* method. This provides the option of replacing the exact value iteration technique with the approximate value iteration technique. This provides for additional speedups in scenarios where an approximate solution is adequate, thereby obtaining simultaneously the benefits of approximate value iteration as well as symbolic heuristic search and the associated masking of unreachable states. In another embodiment, an approximate solution is obtained using approximate linear programming technique.

The optimal solution logic 285 calculates the iterative optimal solution. In one embodiment, the loop breaking logic 290 is provided. After profiling the resulting Symbolic-Heuristic approach on the application domain, it was discovered that an inordinate amount of time was spent in a convergence loop. The loop breaking logic 290 is a task-dependent parameter that allows the optimal solution logic 285 to reduce the amount of time spent in the loop in two ways: (a) limiting the number of iterations by designating a maximum limit, and/or (b) allowing the loop breaking logic 290 to interrupt the loop. The optimal solution logic 285 can re-initiate the computation if necessary. In one embodiment, the optimal solution logic 285 can re-initiate the computation subsequent to run-time use of the policy, by setting the initial state to the latest state encountered while executing the policy.

The errands engine 130 described in FIG. 2 utilizes “Stores” (repositories of resources) and “Resources” (which are found in Stores), and a Shopping List (also referred to as an Errand List). An errands engine creates a “Tour” by visiting Stores and picking up Resources until the Shopping List is empty. This Tour is then sent to the user.

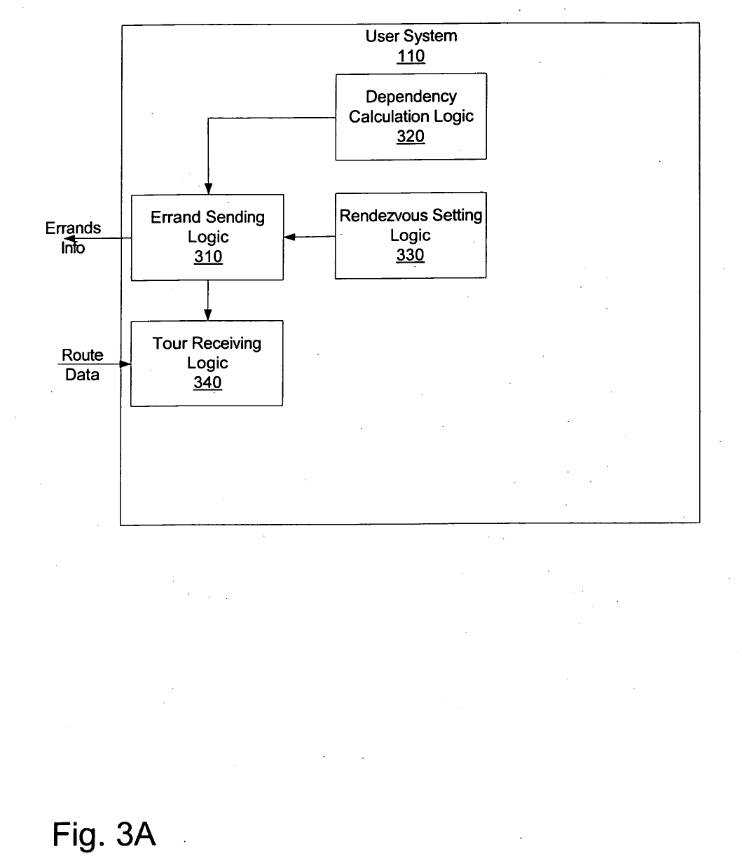

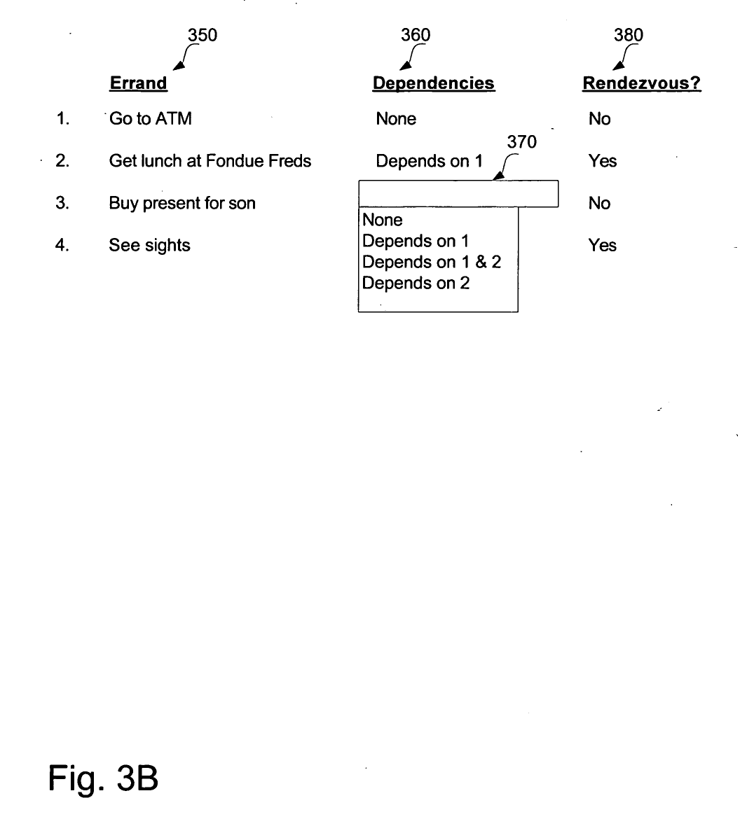

FIG. 3 is a block diagram of one embodiment of the user's system. The errand sending logic sends the errand to the errand engine 130. In one embodiment, the user defines a set of goals. In one embodiment, the user may provide a relative priority, or a dependency between the goals. For example, the user may enter the following:

1. Get money at the ATM

2. Get lunch at Fondue Fred's

2. Purchase present for son, needs ATM

3. See the most important sights of San Francisco

The above list indicates priorities (the ordering) as well as dependencies. In one embodiment, a dependency calculation logic 320 may prompt the user to identify any dependencies. For example, when receiving the above list, the system may query: is going to the ATM needed prior to getting lunch?

Rendezvous setting logic 330 permits the user to identify one or more of the destinations as rendezvous. In one embodiment, only identified locations may be identified as rendezvous. Thus, in the above example, only Fondue Fred's may be designated a rendezvous, since none of the ATM, purchase location, or sight seeing location are specifically identified. In another embodiment, any of the above may be designated as a rendezvous.

In one embodiment, a Web interface is used. In that case, in one embodiment, the interface may appear as shown in FIG. 3B. As can be seen, each Errand 350 has listed next to it a list of dependencies 360. In one embodiment, the dependencies 360 are displayed as a pull-down menu 370. In one embodiment, each possible combination is shown. In another embodiment, only higher priorities (listed in a higher location) are shown. The designation whether an errand is a rendezvous 380 or not is also selected. In this way, the user may simply provide the system sufficient data to create a Tour.

In another embodiment, a knowledge-based system determines typical dependencies appropriate to the user and the given situation, based on a given user profile, and domain knowledge. In one embodiment, the user profile is provided by the user. In another embodiment, the user profile is provided by observing the user over time. In another embodiment, the user profile is obtained by observing a population of similar users. In one embodiment, the domain knowledge is provided by an expert designer. In another embodiment, the domain knowledge is provided by a common-sense knowledge base such as Cyc. In another embodiment, the domain knowledge is provided by an ontology that describes the domain and deductive rules on that domain. In another embodiment, the domain knowledge is provided by observations over a population of similar users.

Returning to FIG. 3A, the user's system includes a Tour Receiving Logic 340 to receive the Tour calculated by the errands engine.

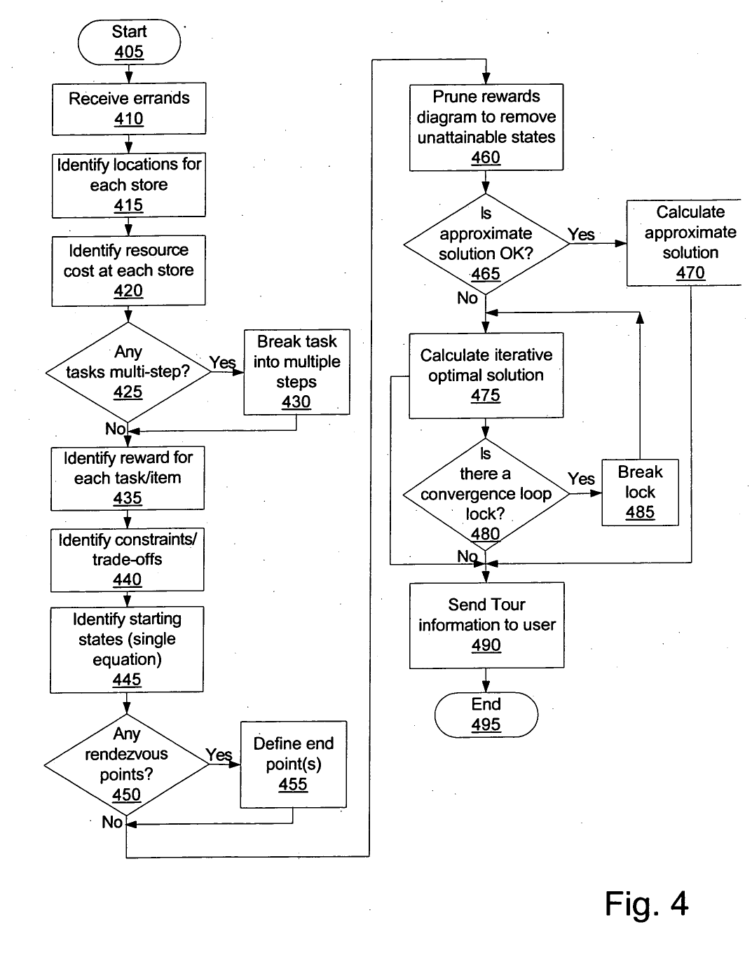

FIG. 4 is a flow diagram of one embodiment of using the errands engine. The process starts at block 405. At block 410, a list of errands is received. In on embodiment, the list of errands includes at least two resources, to be obtained from different stores.

At block 415, the locations for each store are identified. The location of a store, in one embodiment, is obtained from public sources. For example, if the stores are physical stores in a mall, a mall map (generally publicly available on the Internet) may be used to identify the location of each store. In another embodiment, the location of the store is obtained from contractual agreements with private sources, such as from the mall owners, or from marketing agents representing the mall ownership. In another embodiment, the location of the store is obtained from third-party data vendors.

At block 420, the resource cost at each store is identified. As noted above, the resource cost include the transaction cost (travel time, parking costs, etc.) and the actual cost of the item itself. In one embodiment, the actual cost of the item may be unknown. In that instance, only the transaction cost is evaluated. In one embodiment, the inventory of the store is obtained from public sources, such as the internet (e.g., advertisements). In another embodiment, the store inventory is obtained from third-party data vendors. In another embodiment, the store inventory is obtained from a community of cooperating users.

At block 425, the process evaluates whether there are any two-step tasks in the list of errands. Two-step tasks require two separate steps, usually separated by time or location. If there are two-step tasks, at block 430, they are broken up into separate tasks. Note that this feature, along with the ability to stipulate precondition dependencies among goals, effectively allows multi-step tasks having more than two steps.

At block 435, the reward is identified for each task/item. In one embodiment, the user may specify the priority/reward level for one or more of the errands. At its simplest, the user may designate certain errands as “must be done” while others are maintained at “should be done” or “can be done if there is time” priority levels. In one embodiment, prioritizing may be numerical. As in standard task planning, the user may assign a priority level to each errand. The higher the priority, the higher the reward for the completion of the task.

At block 445, the starting states are identified. In one embodiment, all possible starting states are identified, and a single equation which identifies all of the starting states is generated. This single equation is then used to enable the errands engine to calculate Tours for all possible starting states. In another embodiment, all “valid” starting states are identified, where “valid” may mean starting with an empty shopping cart and having not yet visited any locations. A single equation which identifies all of the valid starting states is generated. In another embodiment, a single starting state is identified, and a single equation which identifies the starting state is generated.

At block 450, the process determines whether the user has identified an rendezvous points. Rendezvous points are points at which the tour may terminate. If so, at block 455, the possible end points of the Tour are identified. Otherwise, the process assumes that the ending point can be anywhere, in one embodiment. Note that the rendezvous point may be a point that is not a “store” and that does not have “resources.” For example, for a shopping trip, the rendezvous point may be home.

At block 460, the rewards diagram generated based on the errands list is pruned. The “standard” rewards diagram generated attempts to plot all possible paths, i.e. it is exhaustive. However, there are a large number of states that cannot be reached based on the known starting condition. For example there are states in which a user is in multiple locations at the same time. This is clearly not possible. Therefore, the pruning removes the unattainable paths from the calculations. In one embodiment, this pruning, or masking, means that the values of these paths are never calculated. This leads to significant time savings during the evaluation phase.

At block 465, the process determines whether an approximate solution is acceptable. The system can provide an optimal solution. However, it is less time consuming to provide an approximate solution. If an approximate solution is acceptable, the process continues to block 470. At block 470, the approximate solution is calculated. The approximate solution, as discussed above, in one embodiment, uses the “pair terminal” ADD with the sLAO* method. In another embodiment, the approximate solution is obtained using approximate linear programming.

The process then continues to block 490, and the Tour information is sent to the user. In one embodiment, the Tour is calculated on a computer system remote from the user's portable system. In that instance, the Tour is made available to the user for downloading to the portable system. In another embodiment, this step may be skipped. The process then ends at block 495.

If, at block 465, the approximate solution is not considered acceptable, the process continues to block 475. At block 475, the iterative optimal solution is calculated. In one embodiment, the optimal solution is calculated using the sLAO* method. In another embodiment, the optimal solution is calculated using classical value iteration. In another embodiment, the optimal solution is calculated using classical policy iteration. In another embodiment, the optimal solution is calculated using modified policy iteration. In another embodiment, the optimal solution is calculated using a structured value iteration technique such as SPUDD. In another embodiment, the optimal solution is calculated using a structured value iteration technique such as SPUDD, combined with a reachability masking approach that first performs a reachability analysis from the initial state(s), and then applies the structured value iteration only upon the set of reachable states. In another embodiment, the optimal solution is calculated using classical value iteration, combined with a reachability masking approach that first performs a reachability analysis from the initial state(s), and then applies value iteration only upon the set of reachable states.

At block 480, the process determines whether there is a convergence loop lock. In one embodiment, in testing it was found that an inordinate amount of time was spent in a convergence loop. Therefore, if the convergence loop is detected, the process continues to block 485. At block 485, a task-dependent parameter is used that allows the reasoning agent to reduce the amount of time spent in the loop by two ways: (a) limiting the number of iterations by designating a maximum limit, and (b) allowing the reasoning agent to interrupt the loop. The agent can re-initiate the computation if necessary. The process then return to block 475. In another embodiment, the optimal solution logic 285 can re-initiate the computation during run-time use of the policy, by setting the initial state to the latest state encountered while executing the policy. This allows the MDP solver to focus its computational resources upon exploring only those states reachable from the state corresponding to the current real-world state. If there is no convergence loop, and the optimal solution is successfully computed, the process continues to block 490.

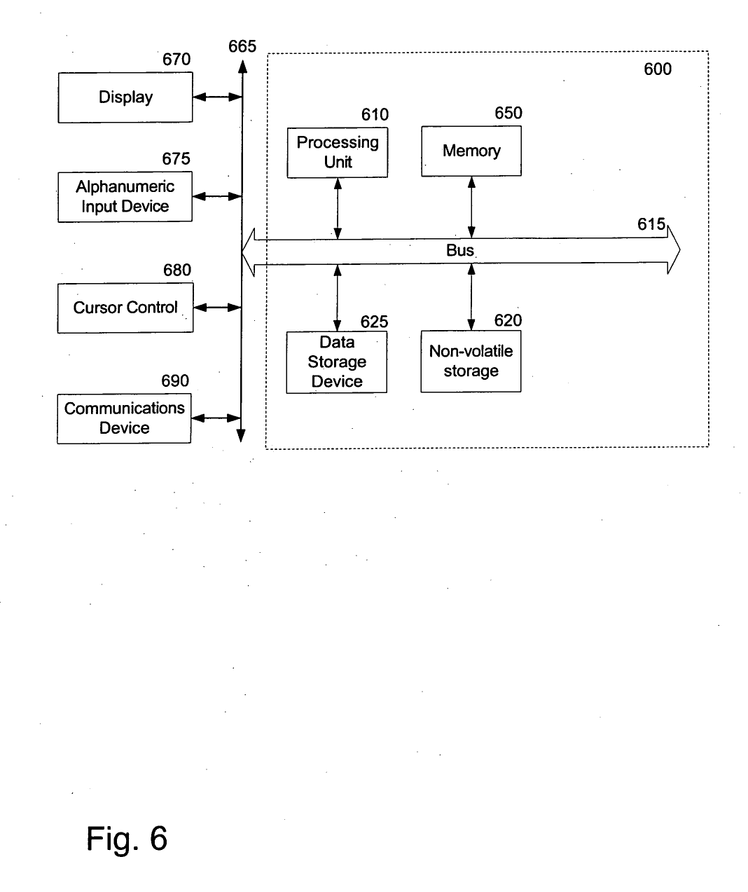

FIG. 6 is one embodiment of a computer system that may be used with the present invention. It will be apparent to those of ordinary skill in the art, however that other alternative systems of various system architectures may also be used.

The data processing system illustrated in FIG. 6 includes a bus or other internal communication means 615 for communicating information, and a processor 610 coupled to the bus 615 for processing information. The system further comprises a random access memory (RAM) or other volatile storage device 650 (referred to as memory), coupled to bus 615 for storing information and instructions to be executed by processor 610. Main memory 650 also may be used for storing temporary variables or other intermediate information during execution of instructions by processor 610. The system also comprises a read only memory (ROM) and/or static storage device 620 coupled to bus 615 for storing static information and instructions for processor 610, and a data storage device 625 such as a magnetic disk or optical disk and its corresponding disk drive. Data storage device 625 is coupled to bus 615 for storing information and instructions.

The system may further be coupled to a display device 670, such as a cathode ray tube (CRT) or a liquid crystal display (LCD) coupled to bus 615 through bus 665 for displaying information to a computer user. An alphanumeric input device 675, including alphanumeric and other keys, may also be coupled to bus 615 through bus 665 for communicating information and command selections to processor 610. An additional user input device is cursor control device 680, such as a mouse, a trackball, stylus, or cursor direction keys coupled to bus 615 through bus 665 for communicating direction information and command selections to processor 610, and for controlling cursor movement on display device 670.

Another device, which may optionally be coupled to computer system 600, is a communication device 690 for accessing other nodes of a distributed system via a network. The communication device 690 may include any of a number of commercially available networking peripheral devices such as those used for coupling to an Ethernet, token ring, Internet, or wide area network. The communication device 690 may further be a null-modem connection, a wireless connection mechanism, or any other mechanism that provides connectivity between the computer system 600 and the outside world. Note that any or all of the components of this system illustrated in FIG. 6 and associated hardware may be used in various embodiments of the present invention.

It will be appreciated by those of ordinary skill in the art that any configuration of the system may be used for various purposes according to the particular implementation. The control logic or software implementing the present invention can be stored in main memory 650, mass storage device 625, or other storage medium locally or remotely accessible to processor 610.

It will be apparent to those of ordinary skill in the art that the system, method, and process described herein can be implemented as software stored in main memory 650 or read only memory 620 and executed by processor 610. This control logic or software may also be resident on an article of manufacture comprising a computer readable medium having computer readable program code embodied therein and being readable by the mass storage device 625 and for causing the processor 610 to operate in accordance with the methods and teachings herein.

The present invention may also be embodied in a handheld or portable device containing a subset of the computer hardware components described above. For example, the handheld device may be configured to contain only the bus 615, the processor 610, and memory 650 and/or 625. The present invention may also be embodied in a special purpose appliance including a subset of the computer hardware components described above. For example, the appliance may include a processor 610, a data storage device 625, a bus 615, and memory 650, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

It will be appreciated by those of ordinary skill in the art that any configuration of the system may be used for various purposes according to the particular implementation. The control logic or software implementing the present invention can be stored on any machine-readable medium locally or remotely accessible to processor 610. A machine-readable medium includes any mechanism for storing or transmitting information in a form readable by a machine (e.g. a computer). For example, a machine readable medium includes read-only memory (ROM), random access memory (RAM), magnetic disk storage media, optical storage media, flash memory devices, electrical, optical, acoustical or other forms of propagated signals (e.g. carrier waves, infrared signals, digital signals, etc.).

The errands engine of the present invention is useful for numerous applications. Some of the exemplary applications in which the present errands engine may be used:

(a) Web Service composition: automatically create composite service from a set of services.

(b) Travel Planning: create a personalized itinerary for visitors to a tourist destination to visit various sites based upon interest level, travel preferences (walking vs. taking mass transit vs. driving).

(c) Shopping Agent: create an itinerary for shoppers visiting a shopping mall given their shopping list and other preferences such as preference ranking among stores and desired price points.

(d) Museum Itinerary Planning: suggest a policy for visiting displays within a museum based upon the visitor's preferences, mobility (energetic single walker vs. slow strolling couple vs. wheelchair-bound).

(e) Device Coordination: given a set of servant devices within a proximity network that are to be utilized by a master device, provides a policy to the master device for optimally visiting the servant devices in order to sequence the devices for the purpose of performing some task. For example, a digital camera takes a snapshot, passes it along to a PDA for image processing to crop the picture and eliminate red-eye from human subjects in the view, sends one hardcopy to a printer at a nearby commercial printer for pick-up at a later time, sends one copy via cell phone to the user's spouse, then directs the GPS device to provide walking directions to the user to locate the commercial printer in order to pick up the hardcopy.

(f) Personal Information Assistant: optimally sequencing the visitation of a set of resources located on a wide-area network (such as the internet or world wide web).

(g) Workflow Tasks: Algorithm is also suitable for automating sequencing useful for creating document workflow or collaboration on a shared project, such as where a document should be directed in order for it to obtain necessary review, approval, and signatures.

(h) Programming game characters

(i) Programming robotic toys.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An errands engine comprising:
an errand receiving logic to receive a set of tasks comprising an errand;
a starting state identification logic to generate a characteristic function that describes a set of valid starting states; and
a solution logic to generate a tour to complete the errand.

2. The errands engine of claim 1, further comprising:
a pruning logic to mask states which are unreachable based on the set of valid starting states.

3. The errands engine of claim 1, further comprising:
a rendezvous logic to define an ending location, wherein the tour terminates at the ending location.

4. The errands engine of claim 1, further comprising:
a cost calculation logic to calculate a cost of obtaining a resource from a store.

5. The errands engine of claim 4, wherein the cost comprises: actual cost and transaction cost.

6. The errands engine of claim 1, further comprising:
a loop breaking logic to terminate a convergence loop.

7. The errands engine of claim 6, wherein the loop breaking logic is configured to limiting the number of iterations by designating a maximum limit.

8. The errands engine of claim 6, wherein the loop breaking logic is configured to allow the errands engine to interrupt the loop.

9. The errands engine of claim 1, further comprising:
errand break-up logic to break multi-step errands into separate tasks.

10. A method of constructing a tour comprising:
receiving a set of tasks comprising an errand;
generating a characteristic function to describe a set of valid starting states; and
generating the tour to complete at least a subset of the tasks, maximizing a reward.

11. The method of claim 10, further comprising:
masking states which are unreachable based on the set of valid starting states.

12. The method of claim 10, further comprising:
receiving one or more rendezvous locations, each rendezvous location being a valid termination point for the tour.

13. The method of claim 10, further comprising:
calculating a cost of obtaining a resource from a store.

14. The method of claim 13, wherein the cost comprises: actual cost and transaction cost.

15. The method of claim 10, further comprising:
identifying a convergence loop; and
terminating the convergence loop.

16. The method of claim 15, wherein terminating the convergence loop comprises:
determining if a number of iterations of the convergence loop have exceeded a maximum limit; and
if the convergence loop has exceeded a maximum limit, terminating the convergence loop.

17. The method of claim 15, wherein terminating the convergence loop comprises interrupting the convergence loop.

18. A system comprising:
a user system to interact with a user to identify a set of tasks for completion;
an errands engine comprising:
a starting state identification logic to generate a characteristic function that describes a set of valid starting states; and
a solution logic to generate a tour to complete the errand.

19. The system of claim 18, wherein the errands engine further comprises:
a pruning logic to mask states which are unreachable based on the set of valid starting states.

20. The system of claim 18, wherein the errands engine further comprises:
a rendezvous logic to define an ending location, wherein the tour terminates at the ending location.

21. The system of claim 18, wherein the user system comprises a system providing a Web Interface to a server.

22. An errands engine comprising:
a receiving logic to receive a plurality of tasks comprising an errand, each task having a completion reward associated with it;
goal encoding to encode the plurality of tasks into a plurality of states and state transitions;
a pruning logic to mask the states and the state transitions which are unreachable; and
a solution logic to generate a tour.

23. The errands engine of claim 22, wherein the tour completes a subset of the plurality of tasks.

24. The errands engine of claim 22, further comprising:
a rendezvous logic to define an ending location, wherein the tour terminates at the ending location.

25. The errands engine of claim 22, wherein:
a cost calculating logic calculates the completion reward, the completion reward comprising a value of a resource minus a cost of obtaining the resource.

26. The errands engine of claim 25, wherein the cost comprises: actual cost and transaction cost.

27. An errands engine comprising:
a means of receiving an errand;
a first means to remove a unreachable states;
a second means to generate a tour based on reachable states not masked by the first means.

28. The errands engine of claim 27, wherein the first means comprises:
a means to encode the goals into a plurality of states; and
a means to mask a subset of the plurality of states that are unreachable.

29. A method comprising:
receiving a plurality of resources to be fetched;
identifying a location for each of the plurality of resources, the location having the resource potentially available;
calculating a tour of the locations; and
ending the tour at a rendezvous location, the rendezvous location defined by the user.

30. The method of claim 29, wherein a plurality of rendezvous locations are received, each rendezvous location being an acceptable termination for the tour.

31. The method of claim 29, wherein the tour includes only a subset of the locations fetching a subset of the resources.

32. A machine readable medium having stored thereon data representing sequences of instructions, which when executed by a computer system, cause said computer system to construct a tour to complete an errand, by performing the steps of:
receiving a list of resources available at various locations, the fetching of the list of resources comprising an errand;
generating a characteristic function to describe a set of valid starting states; and
generating the tour to complete at least a subset of the tasks, the tour designed to maximize a reward.

33. The machine readable medium of claim 32, further having stored thereon data representing sequences of instructions, which when executed by a computer system, cause said computer system to perform the steps of:
masking states which are unreachable based on the set of valid starting states.

34. The machine readable medium of claim 32, further having stored thereon data representing sequences of instructions, which when executed by a computer system, cause said computer system to perform the steps of:
calculating a cost of obtaining a resource from a store, wherein the cost comprises: actual cost and transaction cost.

35. The machine readable medium of claim 32, further having stored thereon data representing sequences of instructions, which when executed by a computer system, cause said computer system to perform the steps of:
identifying a convergence loop; and
terminating the convergence loop.
